(19) United States
(12) Patent Application Publication
(10) Pub. No.: US 2013/0205899 A1
(43) Pub. Date: Aug. 15, 2013

(54) Combo Transducer and Combo Transducer Package

(71) Applicant: Asia Pacific Microsystems, Inc., (US)

(72) Inventors: Chang-Wen Wu, Hsinchu City (TW); Jerwei Hsieh, Hsinchu City (TW); Wu-Chen Yeh, Hsinchu City (TW); Hung-Lin Yin, Hsinchu City (TW); Huai-Wei Hsi, Hsinchu City (TW)

(73) Assignee: ASIA PACIFIC MICROSYSTEMS, INC., Hsinchu City (TW)

(21) Appl. No.: 13/764,780

(22) Filed: Feb. 11, 2013

(30) Foreign Application Priority Data
Feb. 14, 2012 (TW) 101104710

(51) Int. Cl. G01P 1/00

(52) U.S. Cl. CPC G01P 1/00
USPC 73/510

(57) ABSTRACT

A combo transducer includes a base, a proof mass, a membrane unit and a plurality of transducing components. The base is formed with an aperture. The proof mass is disposed in the aperture and has a surface that is formed with a cavity. The membrane unit includes a supporting part connected to the base, a covering part disposed to cover the surface of the proof mass, and a resilient linking part interconnecting the supporting part and the covering part such that the proof mass is movable relative to the base. The transducing components are disposed at the membrane unit. At least one of the transducing components is disposed at the covering part and is registered with the cavity.

### CROSS-REFERENCE TO RELATED APPLICATION

This application claims priority of Taiwanese Application No. 101104710, filed on Feb. 11, 2012.

### BACKGROUND OF THE INVENTION

1. Field of the Invention

The invention relates to a transducer, more particularly to a combo transducer that has multiple functions and a relatively high system integration, and that can be manufactured using microelectromechanical system (MEMS) techniques.

2. Description of the Related Art

Microelectromechanical system (MEMS) is a technology that allows certain devices to be fabricated in very small scale. By combining semiconductor process and micromachining, various sensors and/or actuator components can be fabricated and implemented on a chip.

It is noted that however, on many occasions, more than one physical quantity may be required to be measured. Taking an automobile as an example, an accelerometer and a gyroscope can be integrated on a single chip for measuring the acceleration and orientation of the automobile. An accelerometer and a pressure sensor can be integrated on another chip for monitoring the pressure of tires of the automobile.

Some exemplary prior art publications have disclosed microelectromechanical devices that integrate multiple sensors thereon. For example, U.S. Pat. Nos. 7,223,634, 7,322,236 and 7,555,956 disclose single-chip microelectromechanical devices having both an accelerometer and a pressure sensor. In the prior art publications, the accelerometer and the pressure sensor are juxtaposed on one surface of the microelectromechanical devices, or are respectively disposed on two opposite surfaces of the microelectromechanical devices.

Nonetheless, juxtaposing multiple sensors on a single chip may result in a larger chip size. On the other hand, respectively disposing electrical components on two opposite surfaces of the microelectromechanical devices may lead to a more complicated fabrication process. As a result, the overall production yield may be compromised.

### SUMMARY OF THE INVENTION

Therefore, it is one object of the present invention to provide a combo transducer with higher system integration and that is relatively simple to fabricate.

Accordingly, a combo transducer of the present invention comprises a base, a proof mass, a membrane unit, and a plurality of transducing components.

The base is formed with an aperture. The proof mass is disposed in the aperture and has a surface that is formed with a cavity. The membrane unit includes a supporting part connected to the base, a covering part disposed to cover the surface of the proof mass, and a resilient linking part interconnecting the supporting part and the covering part such that the proof mass is movable relative to the base.

The transducing components are disposed at the membrane unit. At least one of the transducing components is disposed at the covering part and is registered with the cavity.

Another object of the present invention is to provide a combo transducer package that includes the aforesaid combo transducer, and that provides protection to the combo transducer from possible damage attributed to external impact.

Accordingly, a combo transducer package of the present invention comprises a base, a proof mass, a membrane unit, a plurality of transducing components, a capping unit and a substrate.

The base is formed with an aperture. The proof mass is disposed in the aperture and has a surface that is formed with a cavity. The membrane unit includes a supporting part connected to the base, a covering part disposed to cover the surface of the proof mass, and a resilient linking part interconnecting the supporting part and the covering part such that the proof mass is movable relative to the base.

The transducing components are disposed at the membrane unit. At least one of the transducing components is disposed at the covering part and is registered with the cavity.

The capping unit is disposed at one side of the base to cover the membrane unit, and is formed with a recess registered with the covering part and the resilient linking part such that the covering part and the resilient linking part are spaced apart from the capping unit. The substrate is disposed at another side of the base opposite to the one side and is spaced apart from the proof mass.

Preferably, at least one of the capping unit and the substrate is formed with a through hole to communicate fluidly the aperture with an exterior of the base.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic top view of a first preferred embodiment of a combo transducer according to the invention;

FIG. 2 is a schematic sectional view taken along line II-II of FIG. 1;

FIG. 3 is a schematic sectional view of a combo transducer according to a second preferred embodiment of the invention;

FIG. 4 is a schematic sectional view of a combo transducer according to a third preferred embodiment of the invention;

FIG. 5 is a schematic sectional view of a combo transducer according to a fourth preferred embodiment of the invention;

FIG. 6 is a schematic sectional view of a combo transducer according to a fifth preferred embodiment of the invention;

FIG. 7 is a schematic sectional view of a combo transducer according to a sixth preferred embodiment of the invention;

FIG. 8 is a schematic sectional view of a combo transducer package according to an example of the invention;

FIG. 9 is a schematic sectional view of a combo transducer package according to another example of the invention; and

FIG. 10 is a schematic sectional view of a combo transducer package according to yet another example of the invention.

### DETAILED DESCRIPTION OF THE PREFERRED EMBODIMENTS

Before the present invention is described in greater detail, it should be noted that like elements are denoted by the same reference numerals throughout the disclosure.

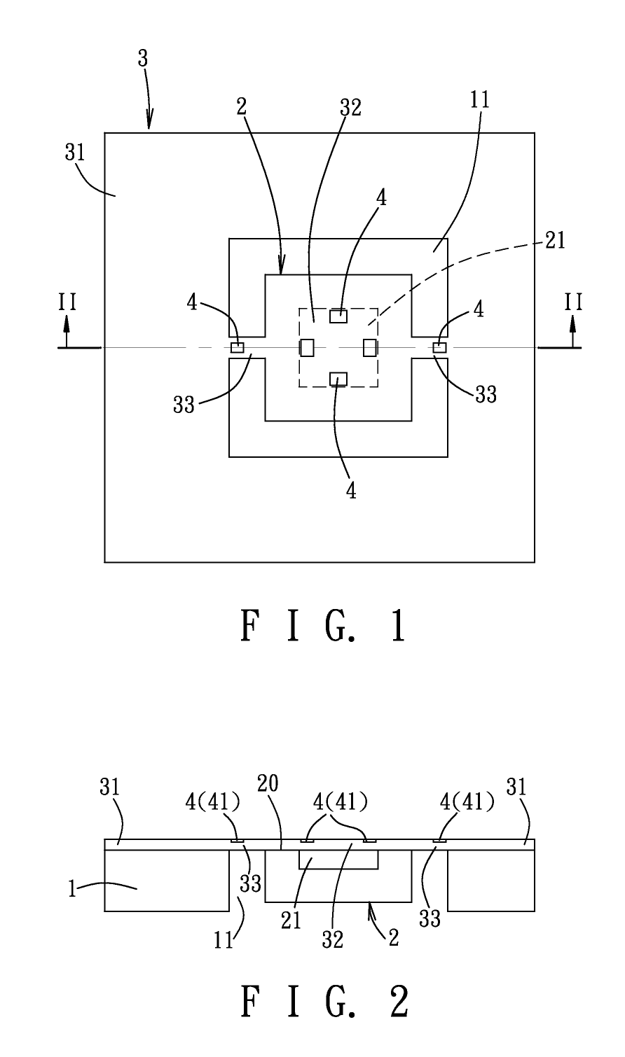

As shown in FIGS. 1 and 2, the first preferred embodiment of a combo transducer according to the present invention comprises a base 1, a proof mass 2, a membrane unit 3, and a plurality of transducing components 4.

The base 1 is formed with an aperture 11. The proof mass 2 is disposed in the aperture 11 and has a surface 20 that is formed with a cavity 21.

The membrane unit 3 includes a supporting part 31 connected to the base 2, a covering part 32, and two resilient linking parts 33. The covering part 32 is disposed to cover the surface 20 of the proof mass 2 and the cavity 21 enables the covering part 32 to deform and/or vibrate in response to pressure change. The resilient linking parts 33 interconnect the supporting part 31 and the covering part 32, such that the proof mass 2 is movable relative to the base 1. Specifically, the proof mass 2 is suspended in the aperture 11 of the base 1 by the resilient linking parts 33, and moves relative to the base 1 in response to external shock. In other embodiments, various numbers and shapes of the resilient linking parts 33 may be implemented for suspending the proof mass 2 with various volume and weight specifications. In some embodiments, only one resilient linking part 33 is sufficient to suspend the proof mass 2.

The transducing components 4 are disposed at the covering part 32 and the resilient linking parts 33 of the membrane unit 3. In this embodiment, each of the transducing components 4 is a piezoresistive component and at least one of the piezoresistive components 41 is disposed at the covering part 32 and is registered with the cavity 21. In operation, the deformation and/or vibration of the covering part 32 is applied to the piezoresistive component 41 thereat as mechanical stress. The motion of the proof mass 2 within the aperture 11 relative to the base 1 is similarly applied to the piezoresistive components 41 at the resilient linking parts 33. As a result, the piezoresistive component 41 at the covering part 32 is for sensing a pressure difference between the cavity 23 and an exterior of the proof mass 2, and the piezoresistive components 41 at the resilient linking parts 33 are for sensing the acceleration and orientation of the proof mass 2, thus serving as an inertial sensor. Therefore, the combo transducer of this embodiment is capable of measuring multiple physical quantities.

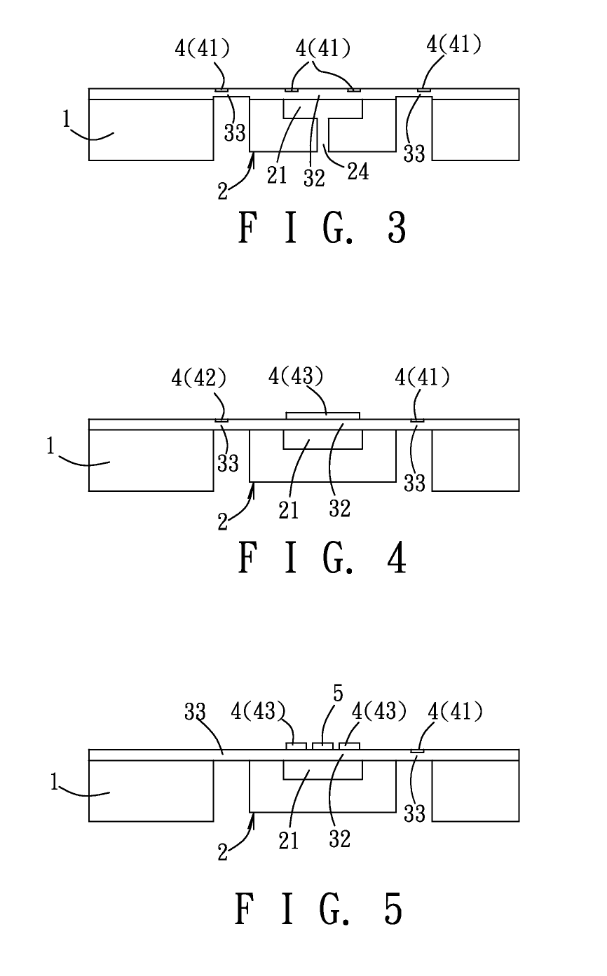

As shown in FIG. 3, the second preferred embodiment of the combo transducer according to the present invention has a structure similar to that of the first embodiment. The main difference between this embodiment and the previous embodiment resides the configurations of the proof mass 2 and the resilient linking part 33 this embodiment, the resilient linking part 33 is made to have a thickness different from that of the covering part 32 and to cover the aperture of the base 1 altogether, such that sensitivities of the piezoresistive components 41 at the resilient linking parts 33 can be adjusted. Additionally, the proof mass 2 is formed with at least one passage 24 to communicate fluidly the cavity 21 with an exterior of the proof mass 2. In this way, the piezoresistive component 41 at the covering part 32 is able to sense the pressure difference between the cavity 23 and an exterior at one of the two sides of the base 1 (an opposite side of the base 1 can be covered by a backend procedure). The second preferred embodiment has the same advantages as those of the first preferred embodiment.

As shown in FIG. 4, the third preferred embodiment of the combo transducer according to the present invention has a structure similar to that of the first preferred embodiment. The main difference between this embodiment and the first preferred embodiment resides in the following. In this embodiment, the transducing components 4 include at least one piezoresistive component 41, at least one piezoelectric component 42 and at least one thermistor component 43.

The piezoresistive component 41 is disposed at one of the resilient linking parts 33 for sensing the acceleration and orientation of the proof mass 2, such that the combo transducer in this embodiment serves as an inertial sensor. The piezoelectric component 42 is disposed at another one of the resilient linking parts 33, and is able to generate a mechanical/electrical signal in response to an externally applied electrical/mechanical signal. Note that, in other embodiments the piezoresistive component 41 and the piezoelectric component 42 can be disposed on an identical one of the resilient linking parts 33. Thus, the combo transducer in this embodiment is able to perform a self-test procedure on the inertial sensing function. The thermistor component 43 is disposed at the covering part 32 and is registered with the cavity 21. The covering part 32 and the cavity 21 serve to reduce heat transfer to and from the proof mass 2, and the thermistor component 43 is for sensing the temperature of an exterior of the base 1. In this way, the combo transducer of this embodiment may serve as both an inertial sensor and a temperature sensor, and can be implemented with a self-test procedure on the inertial sensor. The third preferred embodiment has the same advantages as those of the first preferred embodiment.

As shown in FIG. 5, the fourth preferred embodiment of the combo transducer according to the present invention has a structure similar to that of the first preferred embodiment. The main difference between this embodiment and the first preferred embodiment resides in the following.

In this embodiment, the combo transducer further comprises a heat generating component 5 that is disposed at the covering part 32 and is registered with the cavity 21. The transducing components 4 include at least one piezoresistive component 41 and at least two thermistor components 43.

The piezoresistive component 41 is disposed at one of the resilient linking parts 33 for sensing the acceleration and orientation of the proof mass 2, such that the combo transducer in this embodiment serves as an inertial sensor. The thermistor components 43 are disposed at the covering part 32, are proximate to the heat generating component 5, and are registered with the cavity 21. The covering part 32 and the cavity 21 serve to reduce heat transfer to and from the proof mass 2, and the thermistor components 43 are for sensing a local temperature of the exterior of the base 1, and is able to cooperate with the heat generating component 5 such that the combo transducer in this embodiment may serve as a thermal mass flow meter. Specifically, the thermistor components 43 are disposed respectively at an upstream measuring point and a downstream measuring point of the thermal mass flow meter, and are able to determine flow using a local temperature difference between therebetween. The fourth preferred embodiment has the same advantages as those of the first preferred embodiment.

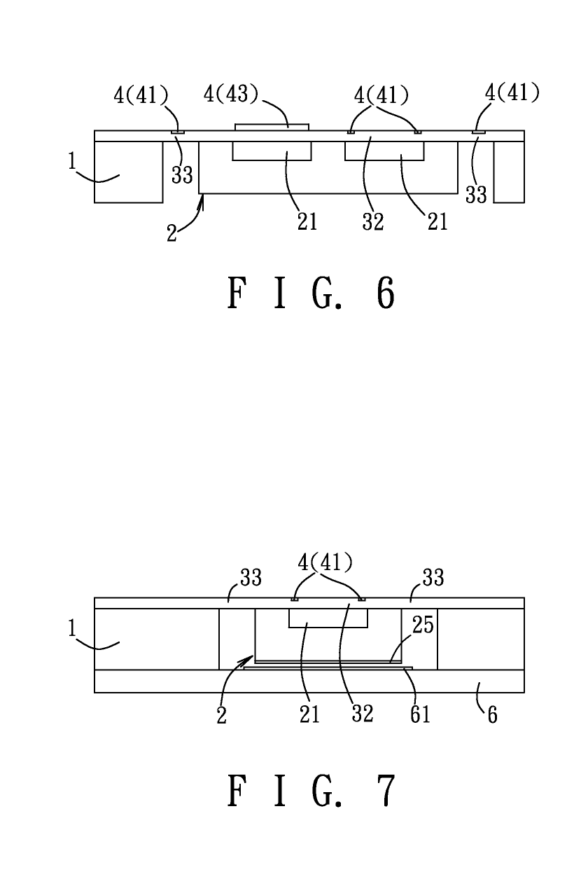

As shown in FIG. 6, the fifth preferred embodiment of the combo transducer according to the present invention has a structure similar to that of the first preferred embodiment. The main difference between this embodiment and the first preferred embodiment resides in the following.

In this embodiment, the proof mass 2 is formed with two cavities 21. The transducing components 4 include a plurality of piezoresistive components 41 and at least one thermistor component. 43.

The piezoresistive components 41 are disposed respectively at the covering part 32 and registered with one of the cavities 21, and at the resilient linking parts 33. The thermistor component 43 is disposed at the covering part 32 and is registered with the other one of the cavities 21. In this way, the combo transducer of this embodiment may serve as an inertial sensor, a pressure sensor and a temperature sensor. The fifth preferred embodiment has the same advantages as those of the first preferred embodiment.

As shown in FIG. 7, the sixth preferred embodiment of the combo transducer according to the present invention has a structure similar to that of the first preferred embodiment. The main difference between this embodiment and the first preferred embodiment resides in the following.

In this embodiment, the proof mass 2 is provided with a first electrode 25, and the combo transducer further comprises a substrate 6 that is connected to the base 1 and that is provided with a second electrode 61 that cooperates with the first electrode 25 to form a capacitor.

Since that the capacitor is partly formed by the proof mass 2, the movement of the proof mass 2 imposes a capacitance change of the capacitor. Alternatively, the capacitor can be charged externally to actuate the proof mass 2. In this way, the combo transducer of this embodiment may serve as both an inertial sensor and a pressure sensor, and can be implemented with a self-test procedure on the inertial sensor. The sixth preferred embodiment has the same advantages as those of the first preferred embodiment.

The above described embodiments of this invention can be fabricated using Microelectromechanical system (MEMS) technology, such that a large number of the combo transducers can be fabricated on a single wafer.

In some embodiments, the combo transducer of this invention can be implemented as a part of a combo transducer package. The combo transducer package is more resistive to damage from external forces, and can be implemented with additional components for providing more versatility.

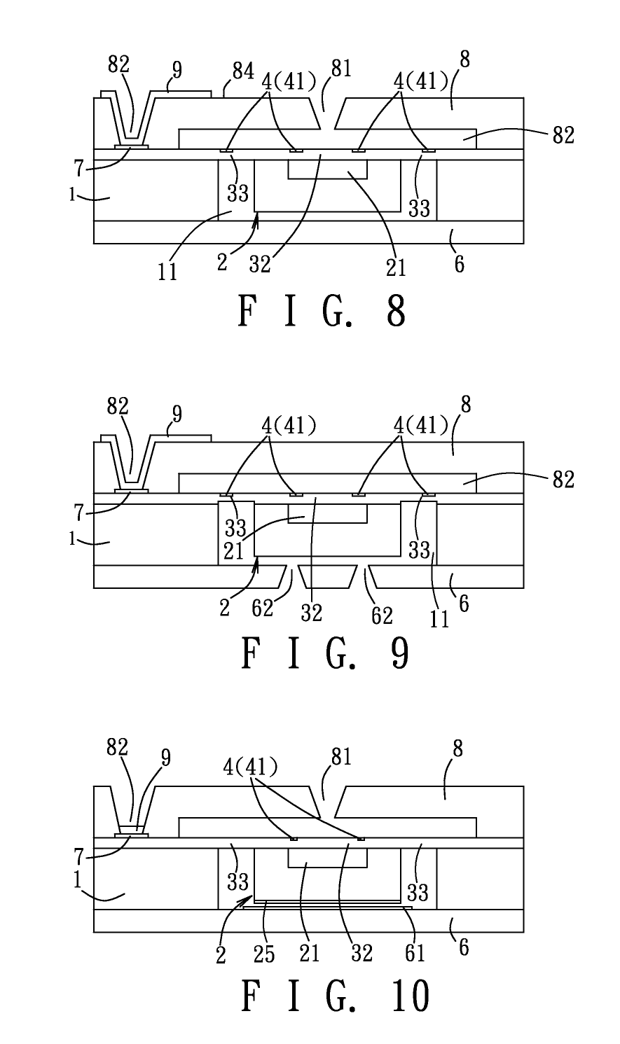

As shown in FIG. 8, a combo transducer package in an example according to the present invention comprises a combo transducer as illustrated in FIG. 2, a substrate 6 a capping unit 8, and a plurality of electrically conductive parts 9. The combo transducer further includes a plurality of bonding pads 7 (only one of the bonding pads 7 and one of the electrically conductive parts 9 are illustrated in FIG. 8). The details of the combo transducer are omitted herein for sake of brevity.

The capping unit 8 is disposed at one side of the base 1 to cover the membrane unit 3, and is formed with a recess 82 registered with the covering part 32 and the resilient linking part 33 such that the covering part 32 and the resilient linking part 33 are spaced apart from the capping unit 8, and can move freely relative to the base 1. The substrate 6 is disposed at another side of the base 1 opposite to the one side, and is spaced apart from the proof mass 2. This s structure is able to prevent the proof mass 2 and the resilient linking parts 33 from possible damage attributed to external impact.

The bonding pads 7 are disposed at one side of the base 1. Each of the bonding pads 7 is for connecting electrically to at least one of the transducing components 4. In this embodiment, the bonding pads 7 and the transducing components 4 are alternately disposed at the membrane unit 3 (e.g., in form of a wheatstone bridge). The capping unit 8 is formed with a first through hole 81 and a plurality of second through holes 82 (only one of which is illustrated in FIG. 8). The first through hole 81 is for communicating fluidly the aperture 11 with the exterior of the base 1. Each of the second through holes 82 is registered with a respective one of the bonding pads 7. Each of the electrically conductive parts 9 is disposed at a corresponding one of the second through holes 82 to connect with the respective one of the bonding pads 7, and extends outwardly of the corresponding one of the second through holes 82 to an outer surface 84 of the capping unit 8. As a result, the combo transducer package of this example is configured to be connected to external circuitry via the electrically conductive parts 9. For example, the electrically conductive parts 9 can be bonded to a circuit board using solder joints, thereby connecting the combo transducer package to the circuit board.

As shown in FIG. 9, a combo transducer package in another example according to the present invention comprises a combo transducer as illustrated in FIG. 2 (i.e., the proof mass 2 is riot formed with a passage), the substrate 6, the capping unit 8, and the electrically conductive parts 9. The combo transducer further includes a plurality of bonding pads 7. The details of the combo transducer are omitted herein for sake of brevity. In this example, the substrate 6 is formed with at least one through hole 62 for connecting fluidly the aperture 11 with the exterior of the base 1.

As shown in FIG. 10, a combo transducer package of yet another example according to the present invention comprises a combo transducer as illustrated in FIG. 7 (i.e., the proof mass 2 is provided with the first electrode 25, and the substrate 6 is provided with the second electrode 61 for forming a capacitor), the bonding pads 7, the capping unit 8, and the electrically conductive parts 9. In this example, the electrically conductive parts 9 do not extend outwardly of the corresponding second through holes 82, and the combo transducer package of this example is configured to be connected to the external circuitry (e.g., a circuit board) by wire bonding the electrically conductive parts 9 thereto.

It is noted that the combo transducer package of the above examples can be fabricated by first fabricating the combo transducer using MEMS on a wafer, and to package other components of the combo transducer package (the substrate 6, the bonding pads 7, the capping unit 8, and the electrically conductive parts 9) onto the combo transducer using wafer-level packaging technology, such that a large number of the combo transducer packages can be fabricated on a single wafer.

To sum up, the proof mass 2 is suspended in the aperture 11 by the resilient linking part 33 and is movable relative to the base 1, such that the movement (acceleration and orientation) can be measured by the piezoresistive component 41 and/or the capacitor formed by the first and second electrodes 25, 61. The cavity 21 of the proof mass 2 allows the covering part 32 to be disposed with various transducing components 4 so as to permit various physical quantity measurements. In other words, the size of the combo transducer does not need to be enlarged in order to accommodate the increased number of transducing components 4. Moreover, the whole combo transducer package can be fabricated using relatively common fabrication procedures.

While the present invention has been described in connection with what are considered the most practical and preferred embodiments, it is understood that this invention is not limited to the disclosed embodiments but is intended to cover various arrangements included within the spirit and scope of the broadest interpretation seas to encompass all such modifications and equivalent arrangements.

What is claimed is:

1. A combo transducer comprising:
a base formed with an aperture;
a proof mass disposed in said aperture and having a surface that is formed with a cavity;
a membrane unit including a supporting part connected to said base, a covering part disposed to cover said surface of said proof mass, and a resilient linking part interconnecting said supporting part and said covering part such that said proof mass is movable relative to said base; and
a plurality of transducing components disposed at said membrane unit, wherein at least one of said transducing components is disposed an said covering part and is registered with said cavity.

2. The transducer of claim 1, wherein each of said transducing components is one of a piezoresistive component, a piezoelectric component and a thermistor component.

3. The combo transducer of claim 2, wherein at least one of said transducing components is a piezoresistive component and is disposed at said resilient linking part.

4. The combo transducer of claim 2, further comprising a heat generating component disposed at said covering part and registered with said cavity, at least one of said transducing components being a thermistor component and being disposed at said covering part proximate to said heat generating component and being registered with said cavity.

5. The combo transducer of claim 1, wherein said covering part and said resilient linking part are formed integrally.

6. The combo transducer of claim 5, wherein said resilient linking part has a thickness different from that of said covering part.

7. The combo transducer of claim 1, wherein said proof mass is formed with at least one passage to communicate fluidly said cavity with an exterior of said proof mass.

8. The combo transducer of claim 7, further comprising a substrate that is connected to said base and that is formed with a through hole to communicate fluidly said aperture with an exterior of said base.

9. The combo transducer of claim 1, wherein said proof mass is provided with a first electrode, said combo transducer further comprising a substrate that is connected to said base and that is provided with a second electrode cooperating with said first electrode to form a capacitor.

10. A combo transducer package comprising:
a base formed with an aperture;
a proof mass disposed in said aperture and having a surface that is formed with a cavity;
a membrane unit including a supporting part connected to said base, a covering part disposed to cover said surface of said proof mass, and a resilient linking part interconnecting said supporting part and said covering part such that said proof mass is movable relative to said base;
a plurality of transducing components disposed at said membrane unit, wherein at least one of said transducing components is disposed at said covering part and is registered with said cavity;
a capping unit disposed at one side of said base to cover said membrane unit, said capping unit being formed with a recess registered with said covering part and said resilient linking part such that said covering part and said resilient linking part are spaced apart from said capping unit; and
a substrate disposed at another side of sa d base opposite to said one side and spaced apart from said proof mass;
wherein at least one of said capping unit and said substrate is formed with a first through hole to communicate fluidly said aperture with an exterior of said base.

11. The combo transducer package of claim 10, further comprising a plurality of bonding pads disposed at said one side of said base for being electrically connected to at least one of said transducing components

12. The combo transducer package of claim 11, wherein said capping unit is formed with a plurality of second through holes, each being registered with a corresponding one of said bonding pads.

13. The combo transducer package of claim 12, further comprising a plurality of electrically conductive parts each disposed at a corresponding one of said second through holes to connect with a respective one of said bonding pads.

14. The combo transducer package of claim 13, wherein each of said electrically conductive parts extends outwardly of the corresponding one of said second through holes to an outer surface of said capping unit.

15. The combo transducer package of claim 10, wherein said proof mass is formed with an least one passage to communicate fluidly said cavity with an exterior of said proof mass, and said substrate is formed with said through hole.

16. The combo transducer package of claim 10, wherein each of said transducing components is one of a piezoresistive component, a piezoelectric component and a thermistor component.

17. The combo transducer package of claim 10, wherein at least one of said transducing components is a piezoresistive component and is disposed at said resilient linking part

18. The combo transducer package of claim 10, wherein said proof mass is provided with a first electrode, and said substrate is provided with a second electrode that cooperates with said first electrode to form a capacitor.
